(19) United States
(12) Patent Application Publication
(10) Pub. No.: US 2005/0256768 A1
(43) Pub. Date: Nov. 17, 2005

(54) Method and system for enabling electronic commerce through advertisements

(76) Inventor: Ray Robinson, Washington, DC (US)

Correspondence Address: Ray Robinson, III, Apt. 1103-N, 2510 Virginia Avenue NW, Washington, DC, 20037, US

(21) Appl. No.: 10/843,258

(22) Filed: May 12, 2004

(51) Int. Cl. G06F 17/60

(52) U.S. Cl. 705/14

(57) ABSTRACT

A computer system for conducting electronic commerce through advertisements. The system transmits the advertisements to prospective customers' computers or other electronic devices via the Internet, World Wide Web or other electronic system. When the user clicks on or otherwise chooses to interact with the advertisement, the system opens direct communication with the advertiser's system. The system then provides the prospective customers with some or all of the following options: establishing live communication with the advertiser's representatives through text chat or video conferencing, browse products, request product information, make a purchase, calculate financing costs and obtain pricing or other product information. Interaction with the advertiser occurs without having the prospective customer referred, hyper linked or otherwise taken to the advertiser's system or Web site. The system allows advertisers to update or change the content of the advertisements themselves, without having a new advertisement created. The system thus allows prospective buyers to gather product information and engage in electronic commerce without being taken away from the original content they were viewing. At the same time, it allows advertisers to update their advertising content in a quicker, more streamlined manner.

### CROSS-REFERENCE TO RELATED APPLICATIONS

This application claims the benefit of PPA Ser. No. 60/468,047, filed May 6, 2003 by the present inventor.

### FEDERALLY SPONSORED RESEARCH

Not applicable

### SEQUENCE LISTING OR PROGRAM

Not applicable

### BACKGROUND OF THE INVENTION

1. Field of Invention

This invention relates to advertisements delivered to personal computers and other electronic devices via the Internet, World Wide Web or other network system, specifically to advertisements that allow the prospective customer to conduct electronic commerce while remaining anchored on the page that originally delivered the advertisement.

2. Background of the Invention

The development of the Internet and the World Wide Web ushered in a new era of electronic commerce, or “e-commerce”, in which transactions between customers and sellers were conducted on vast electronic networks connecting the customer's personal computer and the seller's inventory and order fulfillment system.

A key part of electronic commerce is the use of those networks to deliver advertisements that make customers aware of the availability of products and services. The model of electronic advertising has been patterned after print advertising. The advertisements are inserted into news, entertainment and information content that are thought by the advertiser to be of interest to the customer.

Advertising has thus been seen as the revenue stream for electronic content delivered via computer networks just as it has been for newspapers and magazines.

As currently practiced over the Internet and World Wide Web, advertisements are usually graphic files residing on computer servers dedicated to providing advertisements. An advertisement is inserted into the content of a Web page by adding a reference to its file name and World Wide Web address of the advertising server to the Hyper Text Markup Language (HTML) code of the Web page. HTML is the primary programming language used to describe the display of content on the World Wide Web. It is governed by the HTML 4.01 specification, a revision of the HTML 4.0 specification issued by the World Wide Web Consortium on Dec. 18, 1997.

Electronic advertising has seen a number of new developments, but all of them have centered on making the visual presentation of the advertisements more compelling or broadening the number and types of devices on which the customer could receive advertisements. For example, a method of extending electronic advertising to video games is described in U.S. Pat. No. 6,616,533 to Rashkovskiy (2003).

U.S. Pat. No. 6,625,581 to Perkowski (2003) described a method and system that allows the customer user to retrieve product information and complete a purchase without disturbing his point of presence on the World Wide Web. But the method requires a separately encoded “servlet” (module of program code) for each product. It additionally uses a database to send the proper servlet to users when they click on an advertisement.

The present invention differs in that it is specific to a single vendor, whereas U.S. Pat. No. 6,625,581 applies across multiple vendors and is specific to a product. By serving advertisements on a vendor, rather than product-specific basis, the present invention more closely conforms to the business of advertising as it is practiced today.

Additionally, the present invention does not impose the impractical requirement of maintaining a database of products across all vendors.

The other major development has been “contextual advertising”, which uses search engines to serve advertisements that are relevant to the content being viewed to the customers. Such a method and apparatus is described in U.S. Pat. No. 6,615,247 to Murphy (2003).

But until the present invention, there has been a gap between the systems that serve advertisements and those that provide interaction with the customer, including accepting orders and payment.

The only way to connect the customer with the seller's transaction and order fulfillment system has been to hyperlink the advertisement to the to the advertiser's transaction system. This means, in essence, that after clicking or otherwise selecting the advertisement, the customer is transferred to the advertiser's system. The hyperlink technology is the subject of U.S. Pat. No. 4,873,662 issued to BT Group (1989) and is currently under litigation.

The need for a hyperlink that transfers the user from the original content to the advertiser transaction system carries a number of disadvantages that are addressed by the present invention:
1) From a customer standpoint, advertisements are frustrating because their display gets in the way of content. Technologies such as pop-up, pop-under and interstitial advertisements have taken an increasingly aggressive approach to grabbing readers' attention. To an extent, they have succeeded. But they have also made it more difficult for readers to access news, information and entertainment content.
2) For content providers, the advertisements are an essential part of their revenue stream. But when customers click on or otherwise choose to interact with the advertisements, they are immediately referred to the advertiser's Web site. Content providers use the average time customers spend on their sites as selling points for advertising. But each time a customer clicks on an ad, that average goes down.
3) Advertisers suffer because of various technological countermeasures taken by customers to suppress the display of advertisements. A growing number of software add-on products offer the ability to partially or completely block the display
4) of advertisements. Additionally, each advertisement carries with it the time and cost of having a new graphic file created by an advertising agency.

These disadvantages have combined to hinder the effectiveness of advertising as a revenue producer for content providers on the Internet and World Wide Web.

### BACKGROUND OF THE INVENTION—OBJECTS AND ADVANTAGES

Accordingly, the objects and advantages of the present invention are:
1) to allow customers to browse, obtain prices and complete e-commerce transactions while remaining anchored at the location where they saw the advertisement. The advertisement is a complete software application, providing the customer with fill functionality, rather than a hyperlink to another site. This provides a smoother user experience for the customer and does not cost the content provider a customer;
2) to allow customers to have more interaction with advertisers by tailoring, pricing and otherwise customizing products to their needs and opening a direct communication channel to the advertiser while anchored on the page that displayed the original advertisement;
3) to allow advertisers to change the content of their advertisements without working through an advertising or creative agency, thus reducing the time and cost involved in placing new advertisements.

### SUMMARY

In accordance with the present invention, the advertisement consists of a fully functional software application that is downloaded to the prospective customer's computer, providing a richer and more full-featured user experience than the current system for delivering advertisements.

### DRAWINGS—FIGURES

FIG. 1 shows the current system architecture that is used in delivering electronic advertisements via the Internet and World Wide Web.

FIG. 2 shows the system architecture for delivering electronic advertisements using the present invention.

FIG. 3 is a flow chart showing the user experience for customers using the current architecture for delivering electronic advertisements.

FIG. 4 is a flow chart showing the user experience for customers using the system architecture of the present invention.

FIG. 5 shows the system architecture of the present invention for management of advertising content.

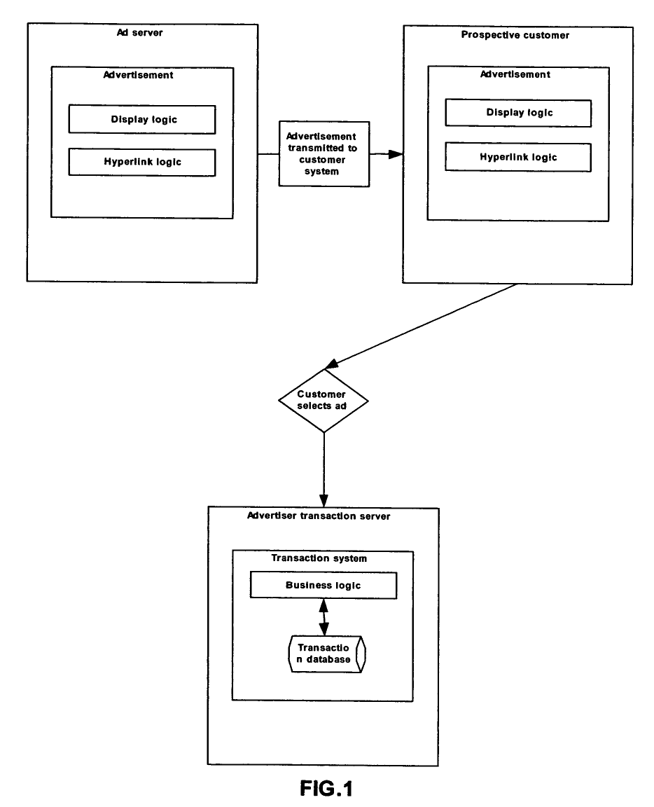

### DETAILED DESCRIPTION—FIG. 1

The current technical architecture for delivering advertisements via the World Wide Web and other electronic networks is illustrated in FIG. 1.

The advertisement is downloaded from an advertising server (“Ad server”) to the user's computer or electronic device (“Prospective customer”) and embedded in the content the user is viewing. Under this architecture, the advertisement is a software application in only the broadest sense of the term.

The only programming logic included in the advertisement governs how it is displayed (“Display logic”) to the user (i.e. size, colors and other visual properties) and where the user will be referred upon clicking or otherwise selecting the advertisement for interaction (“Hyperlink logic”).

The program logic that enables all forms of interaction between the user and advertiser is not available to the user until he or she is transferred by the hyperlink to the advertiser's system (“Advertiser transaction server”). That system includes the actual program logic (“Business logic”) that enables transactions to be completed.

Thus, under this architecture, the advertisement serves only as a means of transferring the user from the content he or she was viewing to the advertiser's system.

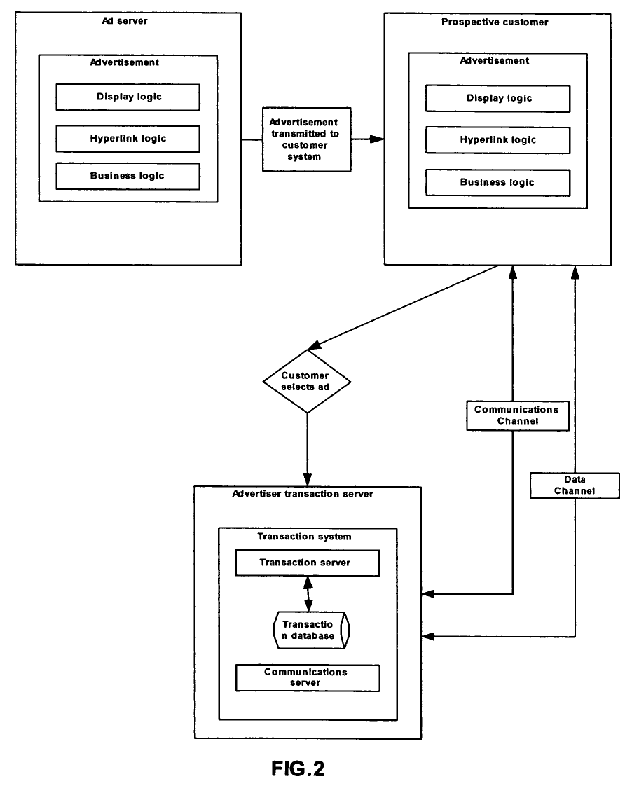

### DETAILED DESCRIPTION—FIG. 2

The technical architecture for the present invention is illustrated in FIG. 2.

Under this architecture, the advertisements are delivered to the user (“Prospective customer”) with all or a portion of the program logic (“Business logic”) that resides on the advertiser system under the technical architecture in FIG. 1.

This relocation of the business logic from the advertiser system to the user's computer or electronic devices enables a higher level of interaction between the user and the advertiser, including the ability to browse inventory, open direct communication and complete transactions. Additionally, this interactivity can be achieved while the user remains anchored in the content he or she was viewing.

When the user selects the advertisement for interaction, the program logic encapsulated in the advertisement opens a direct connection (“Data Channel”) to the advertiser system (“Advertiser transaction server”). This channel is used to exchange the data allowing the user to browse, buy and otherwise interact with the advertiser's transaction system. A second channel (“Communications Channel”) can be opened for direct communication between the user and the advertiser's representatives by audio or video conferencing or text chat.

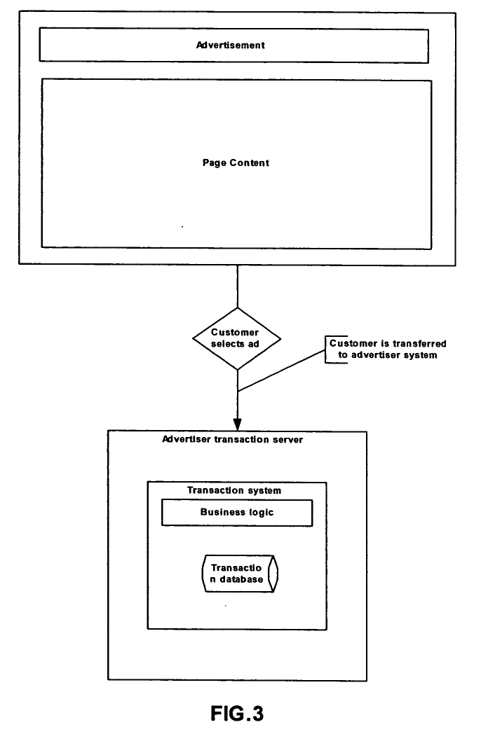

### DETAILED DESCRIPTION—FIG 3.

The user's experience under the current system for delivering electronic advertisements is illustrated in FIG. 3.

The advertisement (“Advertisement”), having been delivered from the advertising server depicted in FIG. 1, is embedded in content that the user is viewing. Where display is concerned, the user experience is not materially different from that of viewing a print ad embedded in a newspaper or magazine page.

When the user (“Customer”) selects the ad, the hyperlink logic depicted in FIG. 1 is triggered, referring the user to the advertiser's transaction system (“Advertiser transaction server”).

This referral takes the form of either a) replacing the content the user was viewing with the advertiser's transaction system; or b) opening a new window displaying the advertiser's transaction system. In either case, the user's experience is disrupted, creating a disincentive for users to interact with advertisements.

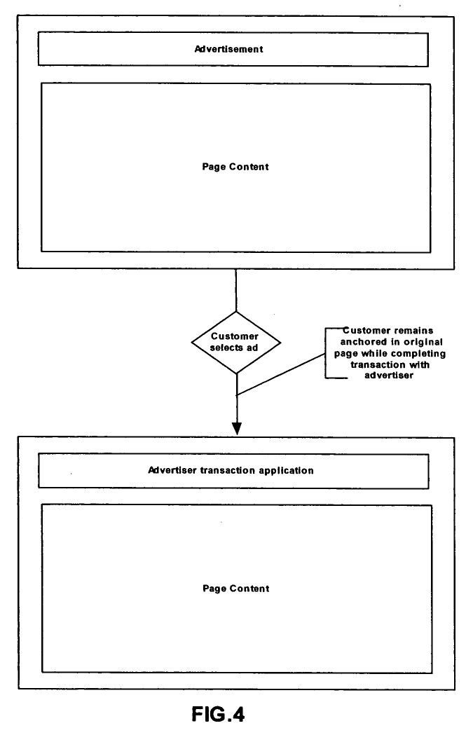

### DETAILED DESCRIPTION—FIG. 4

The user's experience under the present invention is illustrated in FIG. 4.

While the display properties are virtually identical with FIG. 3, when the user (“Customer”) clicks on or selects the advertisement, the program code that is triggered opens an interactive connection to the advertiser's transaction system but does not refer the user to that system by hyperlink.

Instead, the user remains anchored in the content he or she was viewing while interacting with the advertisement. This provides a less disruptive user experience and thus does not discourage users from interacting with the advertisement and ultimately completing a transaction with the advertiser.

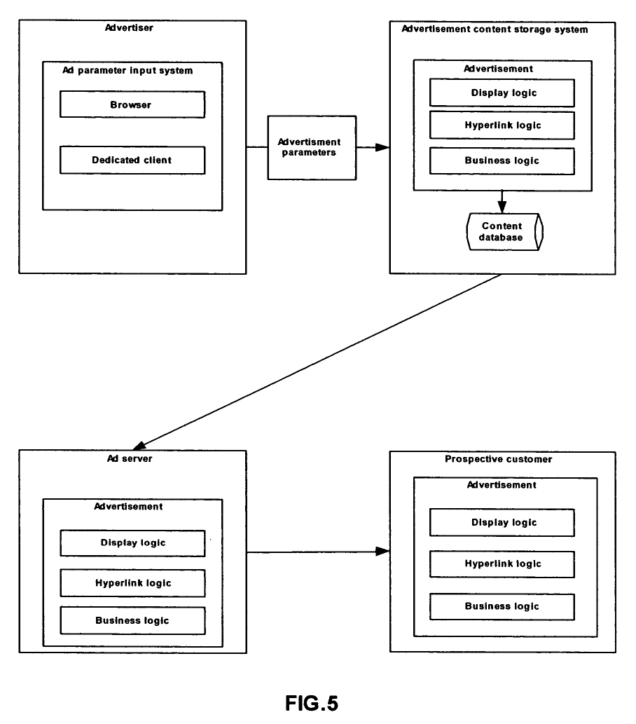

### DETAILED DESCRIPTION—FIG. 5

The technical architecture for advertisement content management under the present invention is illustrated in FIG. 5.

The advertiser's system for managing content of advertisements consists of either a client software application dedicated to content management or a Web browser (“Ad parameter input system”), either of which connect the advertiser to the content management system (“Advertisement content storage system”).

Through this client-server or Web-based system, the advertiser inputs data (“Advertisement parameters”) pertaining to the display and content of the advertisement (i.e. title, text, photographs to display, sounds or videos to play). These content parameters are stored in a database (“Content database”) on the content storage system.

When the advertisement is requested by the advertising server (“Ad server”) for transmittal to a user (“Prospective customer”), the parameters stored in the database are retrieved and used to populate the advertisement along with the display, hyperlink and business logic.

Through this architecture, the advertiser, after having a template created to govern the overall display properties of their advertisements, can change the actual content of the advertisement as often as business requirements dictate.

For example: an airline could have an advertising template created that allows it to feature trips and fares to a given destination. The airline, however, could change the fares and destinations featured by itself without investing the time or money required to have a new advertisement created for each change.

### CONCLUSIONS, RAMIFICATIONS, AND SCOPE

Accordingly, the reader will see that the innovative technical architecture of this invention provides a number of enhancements and improvements over the current method for delivering electronic advertisements:
it allows users or customers to remain anchored in the content they were viewing when they choose to interact with advertisers, leading to a more uniform, less confusing and less irritating user experience;
by keeping customers anchored in the original content, it allows content providers to retain their audience, rather than losing a portion of it each time an advertisement is clicked on;
it allows advertisers to control the content of their own advertisements, thus avoiding the expenditure of time and money involved in creating new advertisements.
it ensures that advertisements will continue to be delivered to customers in a uniform and functional manner, despite changes in the technology of client applications such as Web browsers.

Although the description above contains many specificities, these should not be construed as limiting the scope of the invention but as merely providing illustrations of some of the presently preferred embodiments of this invention. Electronic advertisements that include business and transaction-related programming could be used to enable a variety of interactive features not described in this application.

Thus the scope of the invention should be determined by the appended claims and their legal equivalents, rather than by the examples given.

1. A method and computer system for enabling electronic commerce through advertising, the method consisting of:
transmitting an advertisement to a prospective buyer's computer or other electronic device via the Internet, World Wide Web or other electronic system;
creating a display of the advertisement on the prospective buyer's computer or electronic device;
detecting that the prospective buyer has clicked, selected or otherwise chosen to interact with the advertisement;
opening direct data and communications channels between the prospective buyer's computer or other electronic device and the advertiser's computer system;
allowing the prospective buyer to browse products, services and related information without being hyper linked, referred or otherwise relocated to the advertiser's computer system or World Wide Web page;
allowing the prospective buyer to open live communication with the advertiser's representative or representatives through text chat, video conferencing, audio conferencing or any combination thereof without being hyper linked, referred or otherwise relocated to the advertiser's system or World Wide Web page;
allowing the prospective buyer to complete a purchase by transmitting a product selection and customer information in addition to a credit card or electronic payment information to the advertiser's computer system without being hyper linked, referred or otherwise relocated to the advertiser's computer system or World Wide Web page.
allowing the advertiser to edit, change and manage the content of the advertisement through a World Wide Web or other computer-based interface.

2. The method in claim 1 wherein the prospective buyer can browse products, services and related information without being hyper linked, referred or otherwise relocated to the advertiser's computer system or World Wide Web page.

3. The method in claim 1 wherein the prospective buyer can open live communication with the advertiser's representative or representatives through text chat, video conferencing, audio conferencing or any combination thereof without being hyper linked, referred or otherwise relocated to the advertiser's computer system or World Wide Web page.

4. The method in claim 1 wherein the prospective buyer can complete a purchase by transmitting a product selection and customer information in addition to a credit card or electronic payment information to the advertiser's computer system without being hyper linked, referred or otherwise relocated to the advertiser's computer system or World Wide Web page.

5. The method in claim 1 wherein the advertiser can edit, change and manage the content of the advertisement through a World Wide Web or other computer-based user interface.

6. The method in claim 1 wherein the business logic necessary to browse products and services, complete transactions, open direct communication to the advertiser's computer system, and open live communication with the advertiser is transmitted to the prospective buyer's computer or other electronic device as a computer program that is encapsulated within the advertisement.
